(19) United States
(12) Patent Application Publication
(10) Pub. No.: US 2021/0347240 A1
(43) Pub. Date: Nov. 11, 2021

(54) PROTECTIVE HAIL COVERING SYSTEM FOR VEHICLES

(71) Applicant: Robert Gallegos, Allen, TX (US)

(72) Inventor: Robert Gallegos, Allen, TX (US)

(21) Appl. No.: 17/231,868

(22) Filed: Apr. 15, 2021

Related U.S. Application Data
(60) Provisional application No. 63/020,825, filed on May 6, 2020.

(51) Int. Cl. B60J 11/04

(52) U.S. Cl. CPC B60J 11/04

(57) ABSTRACT

The cover is constructed of an antimicrobial foam material having a thickness of no less than a quarter of an inch to provide optimal protection against hail. A dual mode of fastening ensures both easy and secure fitting of the cover to the vehicle body. Firstly, a series of suction cups is arrayed upon the cover's underside. This method provides a secure and adaptable means of fastening which is passive from an installation perspective, allowing a user to quickly and easy secure the cover, regardless of the vehicle geometry. Secondly, rope fasteners are affixed to the cover around a periphery, such that if the user wants a redundant or more secure fastening mechanism (especially in the event of high winds), the ropes may be tied to the spokes of the vehicle wheels.

### CROSS-REFERENCE TO RELATED APPLICATION(S)

The present application is related to and claims priority to U.S. Provisional Patent Application No. 63,020,825 filed May 6, 2020, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of vehicle cover of existing art and more specifically relates to protective hail cover for automobiles.

### RELATED ART

It has been estimated that in the United States between 2008 and 2014, U.S. insurers paid out over five billion dollars for hail damage claims for automobiles. Hail damage to vehicles represents a massive preventable waste in the contemporary economy. Finances aside, vehicle owners who are forced to total out a vehicle face significant hassle in dealing with claim technicalities and transitioning to a new vehicle.

There have been conceived in the relevant art protective systems which may be applied to a vehicle in order to mitigate hail damage, especially when the vehicle is parked and not in use. However, significant problems exist with the prior art solutions. In order to remain lightweight and manageable, these protective systems tend to provide inadequate protection from significantly sized hail. An addition, covers tend to be inconvenient to install, being offered in a one-size-fits all form factor, and being attached with straps which inconveniently must be passed underneath the vehicle or through a bumper. The resulting cover is a hassle to install and does not fit the vehicle well once in place. There is perceived a need in the industry for a novel protective hail cover which provides ample protection against all magnitudes of hail, which is modular enough to fit all automobiles well, and which is convenient to install and uninstall.

U.S. Pat. No. 5,738,403 to Carolyn L. Tyson relates to a vehicle protective cover. The described vehicle protective cover includes a plurality of lightweight separable panels, each having an inner layer, a thicker shock absorbing center layer, and a substantially thinner outer layer that defines a skirt having plural spaced-apart tie-down lines for securing the cover on the vehicle with the skirt disposed extending from the vehicle in a tensioned, stand-off position. Tyson's solution for a hail protective cover is representative of the prior art. While Tyson makes attempts to improve the protective qualities of the cover against larger hail threats, greater protection is desired. Furthermore, Tyson makes no improvement upon the fastening systems known in the hail protective cover art, and offers no advancement in modularity towards fitting a variety of vehicle designs. A superior solution is yet desired.

### SUMMARY OF THE INVENTION

In view of the foregoing disadvantages inherent in the known vehicle cover art, the present disclosure provides a novel modular protective hail covering system for vehicles. The general purpose of the present disclosure, which will be described subsequently in greater detail, is to provide a modular protective hail covering system for vehicles which is easier to apply, retained more reliably, and provides improved protection against severe hailstorms.

The cover is constructed of an antimicrobial foam material having a thickness of no less than a quarter of an inch to provide optimal protection against hail. A dual mode of fastening ensures both easy and secure fitting of the cover to the vehicle body. Firstly, a series of suction cups is arrayed upon the cover's underside. This method provides a secure and adaptable means of fastening which is passive from an installation perspective, allowing a user to quickly and easy secure the cover, regardless of the vehicle geometry. Secondly, rope fasteners are affixed to the cover around a periphery, such that if the user wants a redundant or more secure fastening mechanism (especially in the event of high winds), the ropes may be tied to the spokes of the vehicle wheels. The rope fasteners are short for this purpose, and provided near at least four corners of the cover, not necessitating the inconvenience of passing the rope fasteners underneath the vehicle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a protective hail covering system for vehicles, constructed and operative according to the teachings of the present disclosure.

FIG. 1 is a perspective view of the protective hail covering system during an ‘in-use’ condition, according to an embodiment of the disclosure.

FIG. 2 is a top perspective view of the vehicle cover of FIG. 1, according to an embodiment of the present disclosure.

FIG. 3 is a bottom perspective view of the vehicle cover 100 of FIG. 1, according to an embodiment of the present disclosure.

FIG. 4 is a perspective view of an alternative embodiment of the vehicle cover 100 of FIG. 1.

FIG. 5 is a top perspective view of an auxiliary-panel of the embodiment of the vehicle cover 100 of FIG. 4, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a vehicle cover and more particularly to a protective hail covering system for vehicles as used to improve the protection of an automobile against hail damage.

Generally, the protective hail covering system for vehicles is a shock absorbing vehicle cover to prevent vehicle damage, such as dents, cracked glass and paint damage. The cover is comprised of 0.25 to 0.50 inch foam shock absorbing squares attached to the vehicle. The squares have extra stabilizing support and are held together with industrial strength hook and loop fasteners on the center edge of each square. The top of the vehicle will have a roll up shock-absorbing foam mat with 10 or more suction cups. The device can be assembled in 5-7 minutes by one person and can be stored in the vehicle or at home. The exact specifications may vary. Preferably, each foam pad is dimensioned approximately seven feet by four feet. The foam pads may be hand stitched together and bound with epoxy to form the assembled vehicle cover. When assembled in this way, including the side protection on the vehicles, the assembled cover may measure eleven feet wide from right-to-left side. Length measurements may depend on the length of the vehicle which the cover is intended for.

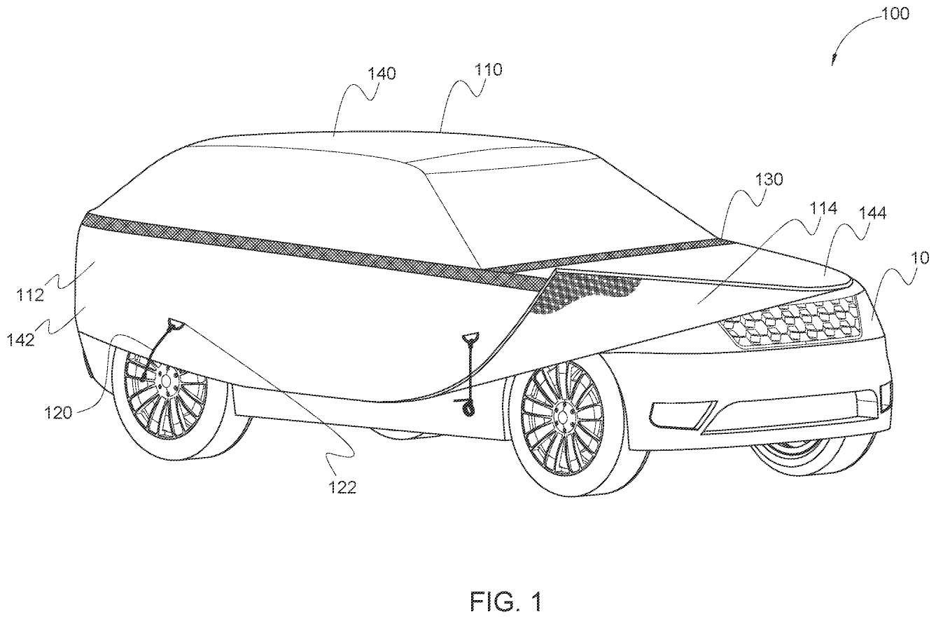

Referring now more specifically to the drawings by numerals of reference, there is shown in FIGS. 1-4, various views of a covering system 100.

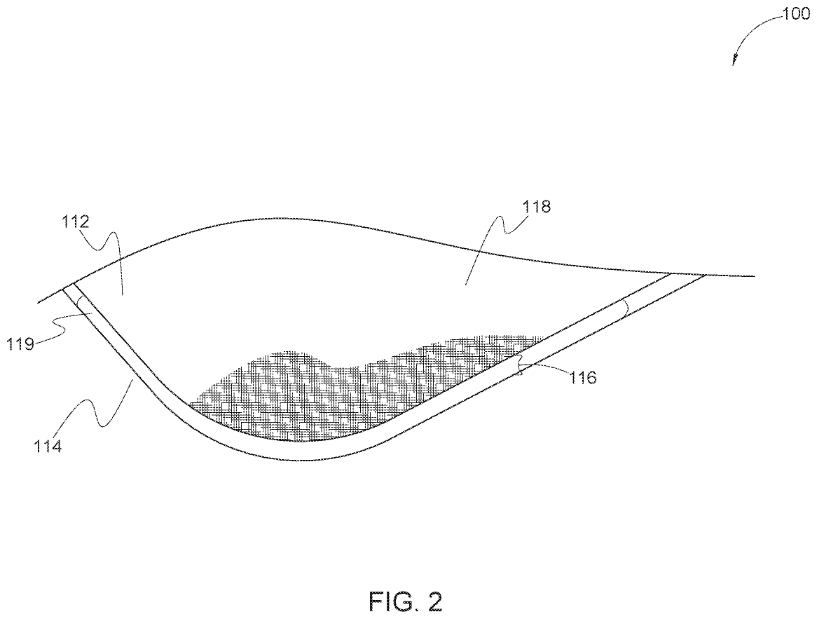

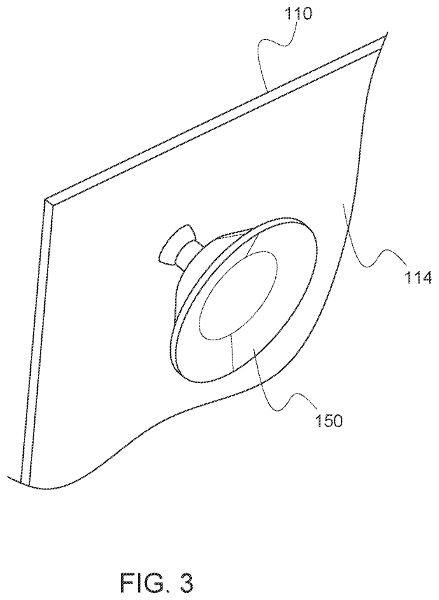

FIG. 1 shows a vehicle cover 100 during an ‘in-use’ condition, according to an embodiment of the present disclosure. Here, the covering system may be beneficial for use by a user to cover a vehicle in order to protect the vehicle from hail impacts. As illustrated, covering system 100 may be applied and affixed to an exterior of a vehicle 10. Covering system 100 may include flexible covering 110, plurality of suction-cups 150 (FIG. 3), and plurality of ropes 120. Flexible covering 110 itself may include anti-microbial foam pad 118 and perimeter 119 (FIG. 2) bounding anti-microbial foam pad 118. Plurality of ropes 120 may be affixed to external-side 112 of anti-microbial foam pad 118. In some embodiments, each of plurality of ropes 120 is affixed to external-side 112 of anti-microbial foam pad 118 by D-ring 122 as illustrated.

In the illustrated embodiment, flexible covering 100 may include center-panel 140, two side-panels 142 stitched to center-panel 140, and front-panel 144 stitched to center-panel 140. In some embodiments, a rear panel may be affixed to center-panel 140 also. The division of flexible covering 100 in this way provides manufacturing expediency so that flexible covering 110 may be shaped in a way to more naturally conform about the sides of vehicle 10 (FIG. 1) without forming creases of excess material at the corners.

FIG. 2 shows the covering system 100 of FIG. 1, according to an embodiment of the present disclosure. As above, the covering system 100 may be constructed of anti-microbial foam pad 118 bounded by perimeter 119. Anti-microbial foam pad 118 may be characterized by thickness 116, which separates external-side 112 from under-side 114. Thickness 116 should not be less than one-quarter of an inch.

FIG. 3 is a bottom perspective view of the vehicle cover 100 of FIG. 1, according to an embodiment of the present disclosure. Shown is underside 114 of flexible covering 110. Plurality of suction-cups 150 may be affixed to under-side 114 of anti-microbial foam pad 118.

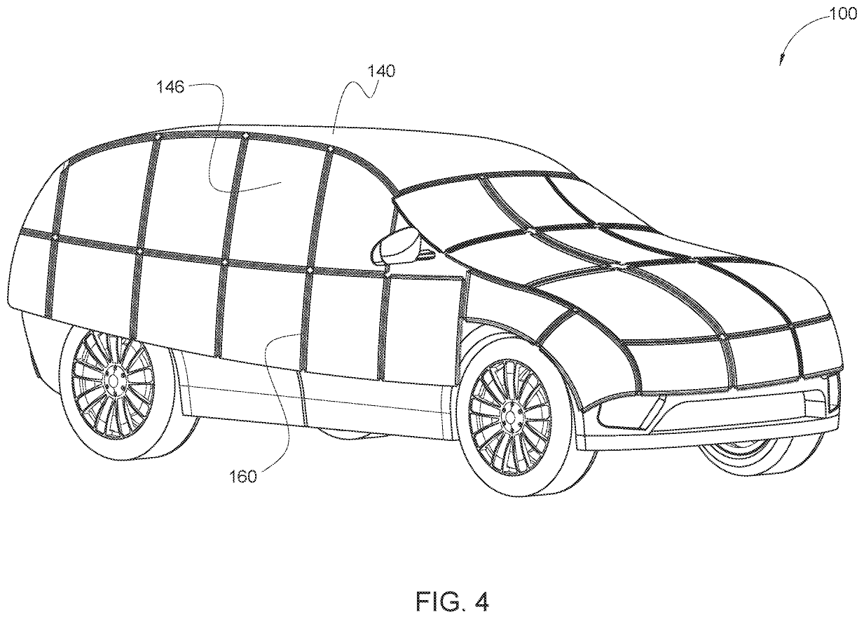

FIG. 4 is a perspective view of an alternative embodiment of the vehicle cover 100 of FIG. 1. In the currently illustrated embodiment, flexible covering may include center-panel 140 and plurality of auxiliary-panels 146. Each of center-panel 140 and plurality of auxiliary-panels 146 may be circumscribed by zippered interface 160, such that each of plurality of auxiliary-panels 146 and center-panel 140 are able to be fastened to each other via zippered interface 160. This system is highly modular so that a user may add or remove additional auxiliary panels to optimize a shape of the vehicle cover 100 to best fit their vehicle without unnecessary excess material. Preferably, each of plurality of auxiliary-panels 146 are square.

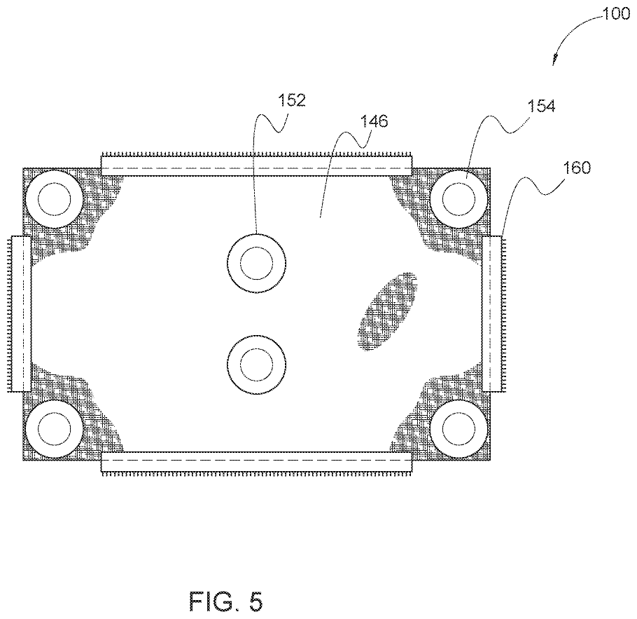

FIG. 5 is a top perspective view of an auxiliary-panel of the embodiment of the vehicle cover 100 of FIG. 4, according to an embodiment of the present disclosure. As shown, plurality of suction-cups 150 may include at least one center-cup 152 affixed centrally to each one of plurality of auxiliary-panels 146 and at least one perimeter-cup 154 affixed to an edge of each one of plurality of auxiliary-panels 146. For the purposes of this specification, “affixed centrally” may mean not within two inches of the periphery. The at least one perimeter-cup 154, by being affixed to an edge, may be within two inches of the periphery of the panel. In this way, each auxiliary-panel 146 is able to securely affix to vehicle 10 (FIG. 1) independently of the other panels.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A covering system applicable to an exterior of a vehicle, the covering system comprising:
a flexible covering comprising
an anti-microbial foam pad having a thickness not less than one-quarter of an inch, the thickness separating an external-side from an under-side, and
a perimeter bounding the anti-microbial foam pad,
a plurality of suction-cups affixed to the under-side of the anti-microbial foam pad; and
a plurality of ropes affixed to the external-side of the anti-microbial foam pad.

2. The covering system of claim 1, wherein the flexible covering comprises
a center-panel;
two side-panels stitched to the center-panel; and
a front-panel stitched to the center-panel.

3. The covering system of claim 1, wherein the flexible covering comprises
a center-panel; and
a plurality of auxiliary-panels;
wherein each of the center-panel and the plurality of auxiliary-panels are circumscribed by a zippered interface, such that each of the plurality of auxiliary-panels and the center-panel are able to be fastened to each other via the zippered interface.

4. The covering system of claim 3, wherein each of the plurality of auxiliary-panels are square.

5. The covering system of claim 3, wherein the plurality of suction-cups comprises at least one center-cup affixed centrally to each one of the plurality of auxiliary-panels and at least one perimeter-cup affixed to an edge of each one of the plurality of auxiliary-panels.

6. The covering system of claim 1, wherein each of the plurality of ropes is affixed to the external-side of the anti-microbial foam pad by a D-ring.

7. A hail-protective covering system applicable to an exterior of a vehicle, the hail-protective covering system comprising:
a flexible covering comprising
an anti-microbial foam pad having a thickness not less than one-quarter of an inch, the thickness separating an external-side from an under-side, and
a perimeter bounding the anti-microbial foam pad,
a plurality of suction-cups affixed to the under-side of the anti-microbial foam pad; and
a plurality of ropes affixed to the external-side of the anti-microbial foam pad;
wherein the flexible covering comprises
a center-panel;
two side-panels stitched to the center-panel; and
a front-panel stitched to the center-panel;
wherein the flexible covering comprises
a center-panel; and
a plurality of auxiliary-panels;
wherein each of the center-panel and the plurality of auxiliary-panels are circumscribed by a zippered interface, such that each of the plurality of auxiliary-panels and the center-panel are able to be fastened to each other via the zippered interface;
wherein each of the plurality of auxiliary-panels are square;
wherein the plurality of suction-cups comprises at least one center-cup affixed centrally to each one of the plurality of auxiliary-panels and at least one perimeter-cup affixed to an edge of each one of the plurality of auxiliary-panels; and
wherein each of the plurality of ropes is affixed to the external-side of the anti-microbial foam pad by a D-ring.
